(19) United States
(12) Patent Application Publication
(10) Pub. No.: US 2025/0036953 A1
(43) Pub. Date: Jan. 30, 2025

(54) SYSTEM AND METHODS FOR LOW-COMPLEXITY DEEP LEARNING NETWORKS WITH AUGMENTED RESIDUAL FEATURES

(71) Applicant: The Regents of the University of California, Oakland, CA (US)

(72) Inventors: Harinath Garudadri, San Diego, CA (US); Kuan-Lin Chen, San Diego, CA (US); Bhaskar D. Rao, San Diego, CA (US); Ching-Hua Lee, San Diego, CA (US)

(21) Appl. No.: 18/715,983

(22) PCT Filed: Dec. 5, 2022
(86) PCT No.: PCT/US22/80954

§ 371 Date: Jun. 3, 2024

Related U.S. Application Data
(60) Provisional application No. 63/286,463, filed on Dec. 6, 2021.

(51) Int. Cl. G06N 3/082

(52) U.S. Cl. CPC G06N 3/082

(57) ABSTRACT

In some example embodiments, there may be provided a method that includes receiving, at a machine learning model, an input for a task of the machine learning model, wherein the machine learning model comprises a plurality of residual blocks augmented with a plurality of augmented weight blocks that sample intermediate features from the plurality of residual blocks; applying the input to the machine learning model to perform the task, wherein the applying comprises applying the plurality of intermediate features, which are obtained from the plurality of residual blocks, to the plurality of augmented weight blocks to form a plurality of intermediate outputs; and generating an output of the machine learning model, wherein the output is generated using at least on a combination of the plurality of intermediate outputs. Related systems, methods, and articles of manufacture are also disclosed.

### CROSS REFERENCE TO RELATED APPLICATION

This application claims priority to U.S. Provisional Application No. 63/286,463 entitled “SYSTEM AND METHODS FOR LOW-COMPLEXITY DEEP LEARNING NETWORKS WITH AUGMENTED RESIDUAL FEATURES” and filed on Dec. 6, 2021, which is incorporated herein by reference in its entirety.

### STATEMENT OF GOVERNMENT SPONSORED SUPPORT

This invention was made with government support under DC015436, and DC015046 awarded by the National Institutes of Health, and U.S. Pat. No. 1,838,897, and CCF2124929 awarded by the National Science Foundation. The government has certain rights in the invention.

### BACKGROUND

Deep neural networks can be used for a variety of machine learning tasks, such as classification (e.g., image classification), speech enhancement, and/or the like. One example of a deep neural network is a residual network (ResNet, see, e.g., He, Kaiming et al., “Deep Residual Learning for Image Recognition,” 2016 IEEE Conference on Computer Vision and Pattern Recognition (CVPR), Las Vegas, NV, USA: IEEE. pp. 770-778). An issue with the ResNet, as well as other deep neural networks, is training. And, as layer quantity grows deeper in the deep neural network, the latency for training increases.

### SUMMARY

In some example embodiments, there may be provided a method that includes receiving, at a machine learning model, an input for a task of the machine learning model, wherein the machine learning model comprises a plurality of residual blocks augmented with a plurality of augmented weight blocks that sample intermediate features from the plurality of residual blocks; applying the input to the machine learning model to perform the task, wherein the applying comprises applying the plurality of intermediate features, which are obtained from the plurality of residual blocks, to the plurality of augmented weight blocks to form a plurality of intermediate outputs; and generating an output of the machine learning model, wherein the output is generated using at least on a combination of the plurality of intermediate outputs.

In some variations of the methods, systems, and computer program products, one or more of the following features can optionally be included in any feasible combination. The task may comprise image classification, object localization, echo cancellation, and/or speech enhancement. The input may be applied to a first linear transformation block to increase a dimensionality of the input. A residual block may include a residual input that is fed forward and summed with the residual input applied to a first nonlinear block and a first linear block to form a residual output. A first intermediate feature may be obtained at a first output of the first nonlinear block. The plurality of augmented weight blocks may each comprise a fully connected neural network and/or a convolutional layer. The machine learning model may be trained using sparse stochastic gradient descent. In response to sparse stochastic gradient descent converging to a first solution during training, one or more weights (which are smaller than a first threshold value) may be set to zero. In response to sparse stochastic gradient descent converging to a second solution during training of remaining non-zero weights, one or more remaining non-zero weights (that are smaller than a second threshold value) may be set to zero.

The details of one or more variations of the subject matter described herein are set forth in the accompanying drawings and the description below. Other features and advantages of the subject matter described herein will be apparent from the description and drawings, and from the claims.

### BRIEF DESCRIPTION OF THE DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 depicts an example of ML model including augmented layers, in accordance with some embodiments;

FIG. 2 depicts an example of ML model without the augmented layers of FIG. 1, in accordance with some embodiments;

FIG. 3A depicts an example of a process for using the ML model including the augmented layers, in accordance with some embodiments;

FIG. 3B depicts an example of a process for sparse stochastic gradient descent during training of the ML model, in accordance with some embodiments; and

FIG. 4 depicts an example of a system, in accordance with some embodiments.

### DETAILED DESCRIPTION

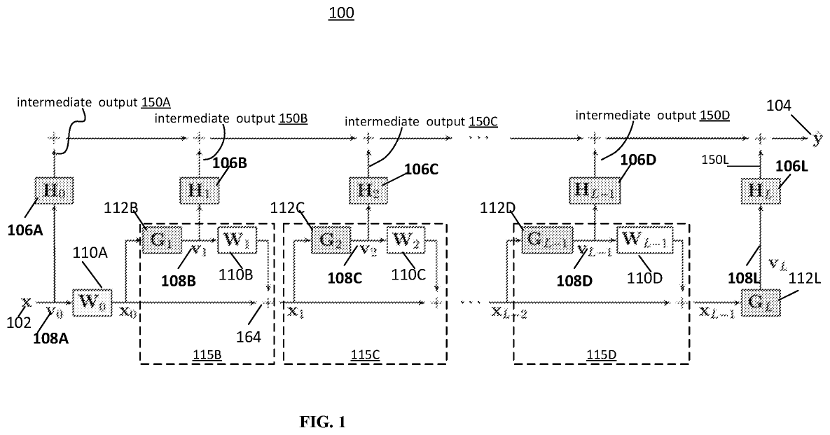

FIG. 1 depicts an example of a ML model 100, in accordance with some embodiments. The ML model 100 may also be referred to as an Augmented Residual Nonlinear Estimator (A-ResNEst). In some embodiments, the ML model 100 includes augmented layers comprising augmented weight blocks 106A-L (H₀-H_{L}). Unlike a traditional ResNet, the output (ŷ) 104 of the ML model 100 is a function of intermediate features 108A-L (v₀-v_{L}) applied to the augmented weight blocks 106A-L (labeled H₀-H_{L}).

The ML model 100 may provide a low-complexity nonlinear estimation framework for a wide range of ML learning tasks, such as supervised learning tasks including, for example, image classification, object localization, echo (or feedback) cancellation, speech enhancement, and/or the like.

Referring to FIG. 1, the input (x) 102 to the ML model 100 may be for example data, such as an image (or portion thereof). For example, the input (x) 102 may take the form of an image vector. The output (ŷ) 104 of ML model may represent an output, such as an estimate or a prediction generated based on the input. During a supervised learning training phase for example, input images may be provide at the input (x) 102, while the output (ŷ) 104 may correspond to labels classifying the input images, so the ML model can learn to predict or estimate. Later, during an inference phase of the ML model (which has been trained) may generate outputs (ŷ) 104 (e.g., predictions, estimates, and/or the like) given other inputs presented as x at 102.

In the example of FIG. 1, the blocks, such as the augmented weight blocks 106A-L (H₀-H_{L}), the nonlinear computation blocks G₁-G_{L} 112B-L, the linear computation blocks W₀-W_{L-1} 110A-D represent computation units or blocks, which are the subject of training during the ML model training phase or once trained provide blocks of the trained ML model 100 for inferences. These blocks may be implemented in a variety of ways, such as using a graphics processor unit (GPU), an artificial intelligence (AI) chip, a ML chip, a neural engine (e.g., specialized hardware that can do fast inference or fast training for neural networks), a single core processor, and/or a multi-core processor.

Although some of the examples herein refer to an input x 102 in the form of an image, other types of data and other types of ML tasks may be implemented as well during training or interference of the ML model.

In some embodiments, the ML model 100 includes the augmented weight blocks 106A-L (H₀-H_{L}). Each of the augmented weight blocks 106A (H₀), 106B (H₁), 106C (H₂), and so forth through 106L (H_{L}) may be implemented as a linear computation block (e.g., a linear transformation block). For example, the linear computation block may comprise a fully connected layer of a neural network or a convolutional layer. In the case of an image for example, the “convolutional layer” computes a convolution of the input image using a kernel filter to extract as output features. The phrase “fully connected layer” refers to a neural network in which each neuron applies a linear transformation to the input vector through a weights matrix, so every input of the input vector influences every output of the output vector.

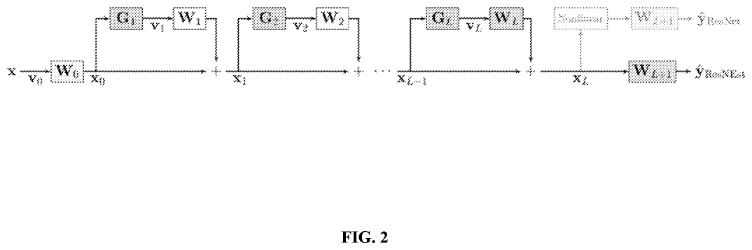

The augmented weight blocks 106A (H₀), 106B (H₁), 106C (H₂), and so forth through 106L (H_{L}) can be viewed as augmented layers to a more traditional ResNet, such as the residual blocks at 115B-115D. FIG. 2 shows an example of a traditional ResNet for purposes of comparison. The ResNet at FIG. 2 is described in He, Kaiming et al., “Deep Residual Learning for Image Recognition,” 2016 IEEE Conference on Computer Vision and Pattern Recognition (CVPR), Las Vegas, NV, USA: IEEE. pp. 770-778.

Referring again to FIG. 1, the input to each of the augmented weight blocks 106A-L (H₀-H_{L}) is an intermediate feature 108A-L (v₀-v_{L}), in accordance with some embodiments. These intermediate features 108A-L represent features sampled at 108A-L along the processing chain of the ML model. For example, intermediate feature 108A (v₀) represents the input 102. And, the intermediate feature 108B (v₁) is the result of the input x 102 (which is expanded to a higher dimension using an input layer such as a linear transformation block 110A) to yield x₀, which is then applied to a nonlinear computational block G₁ 112B to yield the intermediate feature 108B (v₁). And, x₀ is also fed forward and added to the output of the nonlinear transformation block W₁ 110B to form x₁. The input to the residual block 115B is thus x₀ and the output is x₁, which serves as an input to the residual block 115C. The other residual blocks 115C-D operate in a similar manner. At the last residual block, 115D, the output X_{L-1} is applied as an input to nonlinear computational block G_{L} 112L to yield the intermediate feature 108L (v_{L}). And, this intermediate feature 108L is then applied as an input to the linear transformation block H_{L} 106L. The intermediate outputs 150A-L of linear transformation blocks H_{0-L} 106A-L are summed (e.g., combined) to yield the output (ŷ) 104 of the ML model 100.

Referring again to the intermediate feature 108B (v₁), it is applied (e.g., as a matrix-vector multiplication, matrix multiplication, an operation by a fully connected layer, or an operation by a convolutional layer) to augmented weight block H₁ 106B, the output of which (along with the sum of the other augmented weight block outputs (referred to herein as “intermediate outputs” 150A-L)) contribute to the output (ŷ) 104. Similarly, the intermediate features 108C-L are obtained by sampling the output of the nonlinear computation blocks 112C-L (G₁-G_{L}). Thus, the output (ŷ) 104 of the ML model 100 is a function of the intermediate features 108A-L (labeled v₀-v_{L}) applied to the augmented weight blocks 106A-L (labeled H₀-H_{L}).

The nonlinear computation blocks G₁-G_{L} 112B-L may each be implemented using a nonlinear function. For example, nonlinear computation blocks G₁-G_{L} 112B-L may be implemented with a cascade (e.g., series) of a batch normalization (BN) layer, a Rectified Linear Unit (ReLU) layer, a convolutional (CONV) layer, a BN layer, and a ReLU layer (or a subset of these layers).

As noted, the output (ŷ) 104 of the ML model 100 is a function of the intermediate features 108A-L applied to the augmented weight blocks 106A-L, but unlike a traditional ResNet, the ML model 100 may require fewer parameters (e.g., parameters associated with the weights of H₀-H_{L} 106A-L, G₁-G_{L} 112B-L, and W₀-W_{L-1} 110A-110D). Fewer parameters may allow the ML model to be deployed with a smaller memory footprint at a device. Moreover, fewer parameters may mean less latency associated with the training and with inferences.

In some embodiments, the ML model 100 may be trained using sparse stochastic gradient descent (SSGD). Alternatively, the training may include finding the corresponding low-complexity approximate estimator via weight pruning and retraining.

In the example of FIG. 1, the ML model may include a plurality of residual blocks 115B-D, which as noted are augmented with the augmented layers provided by H₀-H_{L}. The input-output relationship of a residual block is represented as follows:

$${x}_{i} = {x}_{i - 1} + {W}_{i} {G}_{i} ( {x}_{i - 1} ; {θ}_{i} ) \qquad ( 1 )$$

wherein i corresponds to the i^{th} residual block, so residual block 115B has i equal to 1, and so forth through L. To illustrate further, the output x₁ of the residual block 115B corresponds to xᵢ, while the input x₀ of the residual block 115B corresponds to xᵢ₋₁. WᵢGᵢ is composed of the nonlinear function Gᵢ (which as noted may be implemented as a cascade of a batch normalization (BN) layer, a ReLU layer, convolutional (CONV) layer, a BN layer, and a ReLU layer) and the linear function block Wᵢ (e.g., a fully connected or a conventional (CONV) layer). The Wᵢ (which is in the set of (ϵ) [symbol] ) forms a linear transformation. And, Gᵢ (xᵢ₋₁; θᵢ): [symbol] [symbol] [symbol] as a function implemented by a neural network or deep neural network (DNN) with parameters θᵢ for all iϵ{1, 2, . . . , L}. θᵢ denotes the set of parameters used by Gi. When θᵢ is changed, the function Gi may be a different function. For example, during training, the performance of Gi may be maximized, and this optimization (or maximization) procedure may be performed by changing θᵢ. The multidimensional expansion of x₀=W₀ x for the input x 102 (xϵ [symbol] ) to the ML model 100 uses, as noted, a linear transformation (e.g., a CONV layer) with a weight matrix W₀ϵ [symbol] . The output ŷ 104ϵ [symbol] (or ŷ_{L-A-ResNEst} to indicate L blocks) of the ML model 100 may be defined as follows:

$${\hat{y}}_{L - A - ResNEst} ( x ) = {\sum }_{i = 0}^{L} {H}_{i} {v}_{i} ( x ) \qquad ( 2 )$$

$$where$$

$${v}_{i} ( x ) = {G}_{i} ( {{x}_{i}}_{1} ; {θ}_{i} ) = {G}_{i} ( {\sum }_{j = 0}^{i - 1} {W}_{j} {v}_{j} ; {θ}_{i} ) . \qquad ( 3 )$$

Referring to equation 2 above, the output ŷ 104 is based on intermediate features 108A-L (v₀-v_{L}) applied as input to the augmented weight blocks 106A-L (H₀-H_{L}) of the augmented layers. Specifically, the output ŷ 104 represents the aggregate (or sum) of the intermediate outputs 150A-L, which are formed by the augmented weight blocks applied (e.g., as a matrix-vector multiplication, matrix multiplication, an operation by a fully connected layer, or an operation by a convolutional layer) to a corresponding intermediate feature 108A-L.

In the notation used, M refers to an expansion factor, and No refers to the output dimension of the ML model. As noted above, the linear computational block W₀ 110A is used to expand the input x₀ to a higher dimension, which in this example is M. Moreover, the number of blocks L is a nonnegative integer, which in the example of FIG. 1 is L (although only 4 are shown).

The ML model 100 may be trained using supervised learning as noted above. To train the ML model 100, the objective is to solve an empirical risk minimization problem represented as follows:

$${min}_{{W}_{0} , … , {W}_{L - 1} , {θ}_{1} , … , {θ}_{L} , {H}_{0} , … , {H}_{L}} ( {W}_{0} , … , {W}_{L - 1} , {θ}_{1} , … , {θ}_{L} , {H}_{0} , … , {H}_{L} ) \qquad ( 4 )$$

$$where$$

$$( {W}_{0} , … , {W}_{L - 1} , {θ}_{1} , … , {θ}_{L} , {H}_{0} , … , {H}_{L} ) = \frac{1}{N} {\sum }_{n = 1}^{N} ℓ ( {\hat{y}}_{L - A - ResNEst} ( {x}^{n} ) , {y}^{n} ) . \qquad ( 5 )$$

wherein 1 denote the loss function and {(xⁿ, yⁿ)}ₙ₌₁^{N} denotes the training data, and wherein W₀-W_{L-1}, θ₁-θ_{L}, and H₀-H_{L} are parameters of the ML model 100 (e.g., A-ResNEst model) being minimized with respect to the empirical risk across the data set (where A represents the empirical risk function or average loss function across a given data set). During training for example, a goal is to find these parameters such that the empirical risk in Equation (5) is minimized or approximately minimized. Regularization terms may be added to the loss function to find parameters achieving a threshold level of performance.

Table 1 below shows an example of results that show that the ML model 100 (column labeled “A-ResNEst”) in general exhibits competitive classification accuracy with fewer parameters when compared to “Standard ResNets”. At Table 1, the classification accuracy corresponds to an average of 7 trials with different initializations, the parameters of the networks are shown in millions (M), and the dataset used for classification is CIFAR-10. Each row of Table 1 represents a different model architecture, such as WRN-16-8, WRN-40-4, etc. In the first row of Table 1, the ML model 100 (“A-ResNEst”) had a classification accuracy of 95.29% while the Standard ResNet had an accuracy of 95.56%, but the ML model 100 (“A-ResNEst”) used 8.7M parameters far fewer than the 11M parameters of the Standard ResNet. The ML Model 100 (A-ResNets) in most cases have fewer parameters than the standard ResNets because they do not have the layers W_{L} and W_{L+1}; and the number of prediction weights in H₀, H₁, . . . . H_{L} is usually not larger than the number of weights in W_{L} and W_{L=1}.

TABLE 1

| | | ML Model 100 |
|---|---|---|
| Model | Standard ResNets | (A-ResNEst) |
| WRN-16-8 | 95.56% (11M) | 95.29% (8.7M) |
| WRN-40-4 | 95.45% (9M) | 95.48% (8.4M) |
| ResNet-110 | 94.46% (1.7M) | 93.97% (1.7M) |
| ResNet-20 | 92.60% (0.27M) | 92.47% (0.24M) |

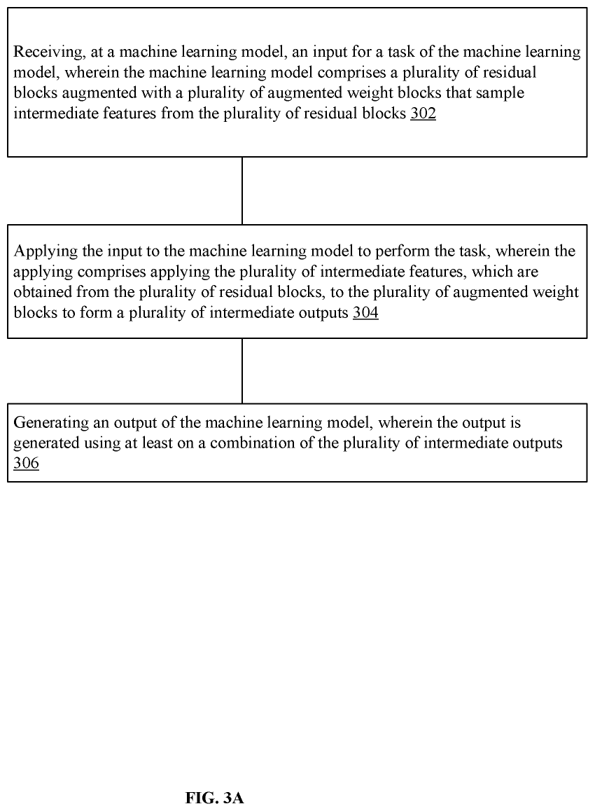

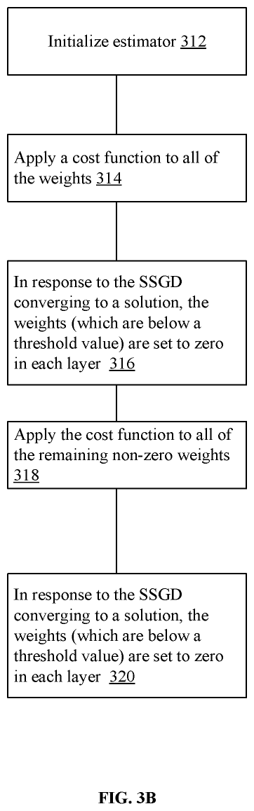

FIG. 3A depicts an example of a process for using a ML model, such as ML model 100, that is augmented with a plurality of augmented weight blocks 106A-L (H₀-H_{L}), in accordance with some example embodiments.

At 302, the ML model, may receive an input for a task of the machine learning model, wherein the machine learning model comprises a plurality of residual blocks augmented with a plurality of augmented weight blocks that sample a plurality of intermediate features from the plurality of residual blocks. For example, the ML model 100 may receive an input, such as data (e.g., one or more images or portions thereof) at x 102. During training for example, the inputs may include labels to train the ML model. During inference, the inputs will not include labels, so the ML model 100 can predict or estimate the output (ŷ) 104 (e.g., a classification or label for the input). The machine learning model may include a plurality of residual blocks, such as blocks 115B-D that are augmented with a plurality of augmented weight blocks (H₀-H_{L}) 106A-L. The augmented weight blocks sample a plurality of intermediate features (v₀-v_{L}) 108A-L from the plurality of residual blocks.

At 304, the input is applied to the machine learning model to perform the task, wherein the applying comprises applying the plurality of intermediate features, which are obtained from the plurality of residual blocks, to the plurality of augmented weight blocks to form a plurality of intermediate outputs. For example, the input x 102 is applied to the ML model, so that the ML model can perform its task (whether during training or inference phase of the ML model). The applying may include using plurality of intermediate features (v₀-v_{L}) 108A-L (which are obtained or sampled from the plurality of residual blocks 115B-D as well as G_{L} 112L and the input x as v₀), to the plurality of augmented weight blocks (H₀-H_{L}) 106A-L to form a plurality of intermediate outputs 150A-L.

At 306, an output of the machine learning model may be generated, wherein the output is generated using at least on a combination of the plurality of intermediate outputs. For example, the ML model 100 may generate the output (ŷ) 104. This output (ŷ) 104 may be generated as a combination of the plurality of intermediate outputs 150A-L.

In some embodiments, the task being learning as part of training or the task being performed as an inference includes image classification, object localization, echo cancellation, and/or speech enhancement.

In some embodiments, the input x 102 is applied to a first linear transformation block W₀ 110A to increase the dimensionality of the input x by forming x₀.

In some embodiments, a residual block, such as residual block 115B, may include a residual input, such as x₀ (as depicted at FIG. 1), which at is fed forward and at 164 summed with the residual input x₀ applied to a first nonlinear block, such as G₁ 112B, and a first linear block, W₁ 110B, to form a residual output, such as x₁. The other residual blocks 115C-D may be configured in the same or similar manner as residual block 115B.

In some embodiments, a first intermediate feature, such as intermediate feature 108B, is obtained at a first output of the first nonlinear block, such as G₁ 112B.

In some embodiments, the plurality of augmented weight blocks, such as H₀-H_{L} 106A-L each comprise a fully connected neural network and/or a convolutional layer.

In some embodiments, the machine learning model is trained using sparse stochastic gradient descent. When this is the case, in response to sparse stochastic gradient descent converging to a first solution during training, one or more weights (which are smaller than a first threshold value) may be set to zero (see, e.g., FIG. 3B at 316) and in response to sparse stochastic gradient descent converging to a second solution during training of the remaining non-zero weights, the one or more remaining non-zero weights (which are smaller than a second threshold value) may be set to zero (see, e.g., FIG. 3B at 320).

### Sparse Stochastic Gradient Descent (SSGD)

In some embodiments, the training of the ML model uses gradient decent, such as stochastic gradient decent or sparse stochastic gradient decent (SSGD). Gradient descent refers to an iterative optimization that finds a local minimum of an objective (e.g., loss) function in n-dimensional space, while stochastic gradient descent refers to an iterative optimization of the objective function that uses a stochastic approximation (e.g., an estimate) of the gradient descent optimization. Rather than use the actual gradient (as determined from the entire dataset as in a gradient descent), the stochastic gradient descent uses an estimate of the gradient (calculated from a randomly selected subset of the data).

In the case of sparse stochastic gradient descent, a sparse matrix is used as further described herein. Let J(θ) be a cost function of a neural network with parameters θ. Let Ok denote the parameters in the k-th layer of the neural network. J is defined as a regularized empirical risk given by

$$J ( θ ) = \frac{1}{N} {\sum }_{n = 1}^{N} ℓ ( \hat{y} ( {x}^{n} ) , {y}^{n} ) + λ {‖ θ ‖}_{2}^{2} \qquad ( 6 )$$

wherein 1 is the loss function, {(xⁿ, yⁿ)}ₙ₌₁^{N} is the training data set, ŷ is the output of the neural network, and A is the regularization constant. To iteratively solve the optimization problem in (6), the following iterative update rule may be used:

$${θ}_{t + 1}^{k} = {θ}_{t}^{k} - η {S}_{t}^{k} {∇}_{{θ}_{k}} J ( θ ) {\vert}_{θ = {θ}_{t}} \qquad ( 7 )$$

wherein Sₜ^{k} is the proportionate (diagonal) matrix of the k-th layer given by

$${[ {S}_{t}^{k} ]}_{i i} = \frac{{( \vert {θ}_{i , t}^{k} \vert + c )}^{2 - p}}{\frac{1}{\vert {θ}^{k} \vert} {\sum }_{i = 1}^{\vert {θ}^{k} \vert} {( \vert {θ}_{i , t}^{k} \vert + c )}^{2 - p}} \qquad ( 8 )$$

for i=1, 2, . . . , |θ^{k}|. This type of update rule may be referred to as a sparse stochastic gradient descent (SSGD). The hyperparameters of SSGD may include p and c such that 1.0≤p≤2.0 and c≥0. The SSGD is built on top of the regularized empirical risk minimization problem. In the case of SSGD and Equations 7 and 8, at each step in the optimization for example, the SSGD algorithm may compute a diagonal matrix whose diagonal elements are positive and proportionate to the magnitude of weights at a current step, and a larger weight may assign a larger positive element in the diagonal matrix. Next, the SSDG algorithm may apply the diagonal matrix to the stochastic gradient, wherein the direction of the stochastic gradient may (or may not) change. The learning rate (or step size) may be applied to the multiplication of the diagonal matrix and the stochastic gradient to update the parameters of the neural network. In this example, the hyperparameters p and c may be tuned for the SSGD algorithm, or the hyperparameters can be fixed or time-varying during the optimization process. Table 2 below depicts some example results using SSGD. In some implementations, a nonzero λ can make a large difference with respect to performance such as accuracy of classification or regression error. Table 2 uses the CIFAR-10 data set with the top-1 test accuracies (%) for different types of deep neural networks, such as VGG-19, ResNet-20, ResNet-56, and wide ResNet (WRN) 16-8. When the weight decay (2) is set to 0, the accuracies drop substantially.

TABLE 2

| | p value | | | | | | | | | |
|---|---|---|---|---|---|---|---|---|---|---|
| | λ = 0.0005 | | | | | λ = 0 | | | | |
| DNN | 1.0 | 1.2 | 1.5 | 1.8 | 2.0 | 1.0 | 1.2 | 1.5 | 1.8 | 2.0 |
| VGG-19 (20M) | 93.86 | 93.96 | 94.18 | 93.82 | 93.74 | 87.33 | 89.47 | 91.06 | 90.68 | 91.10 |
| ResNet-20 (272K) | 92.37 | 92.72 | 92.96 | 93.10 | 93.05 | 88.67 | 89.55 | 90.18 | 90.46 | 91.03 |
| ResNet-56 (856K) | 93.75 | 93.96 | 94.10 | 94.22 | 93.96 | 90.59 | 91.00 | 91.46 | 91.69 | 92.17 |
| WRN 16-8 (11M) | 95.76 | 95.76 | 95.62 | 95.85 | 95.84 | 93.38 | 93.81 | 93.96 | 94.04 | 93.95 |

### Finding Low-Complexity Augmented Residual Features

Compared with residual networks (ResNets), the ML model 100 (A-ResNEsts) may avoid using (or depending on) the final residual representation for the predicted output ŷ. Instead, the ML model 100 (A-ResNEsts) may apply a linear prediction on top of each residual feature vᵢ via the set of augmented weight matrices Hᵢ.

Because deep neural networks are usually very computationally expensive, it is difficult to deploy them on resource-constrained devices. To address this issue during training of the ML model 100, the estimators (e.g., Wᵢ (110A-L), Hᵢ (106A-L), Gᵢ (112A-L)) are implemented using low-complexity by finding sparse solutions (or approximate) estimators that have lower complexity. FIG. 3B depicts an example process for finding a sparse solution, in accordance with some embodiments.

At 312, the estimator may be initialized using, for example, samples obtained from a distribution (e.g., a random distribution). The estimator refers to for example a neural network, such as the ML model 100 (A-ResNEst). At the initialization stage, the parameters of the ML model may be randomly sampled from a probability distribution (e.g., a Gaussian distribution and uniform distribution).

At 314, a cost function of a neural network is applied to all of the weights Wᵢ (110A-D) as part of the training, the weights of Hᵢ (106A-L), and the weight of Gᵢ (112B-112L). For example, a cost function, such as the cost function J (e) of equation 6 above is applied to the weights of Wᵢ (110A-L), the weights of Hᵢ (106A-L), and the weight of Gᵢ (112B-112L).

When the SSGD converges to a solution at 316 as part of the training, all of the weights are set to zero in each layer if they are smaller than a given threshold value. Here, the term layer refers to a computation block, such Gᵢ, Hᵢ, or Wᵢ. Moreover, the threshold in each layer may be different. Alternatively, or additionally, the threshold may be the same. The zero weights permanently remain zero after this step during the subsequent training (e.g., re-training).

At 318, the cost function is again applied to all of the remaining non-zero weights of Wᵢ, Hᵢ, and Gᵢ as part of the re-training of the remaining non-zero weights. At this point, once the SSGD converges to a solution at 320, the solution is selected as a low-complexity approximation of the estimator (e.g., a low complexity A-ResNEst). At 318, the retraining of the remaining non-zero weights fine tunes the performance of the ML model 100.

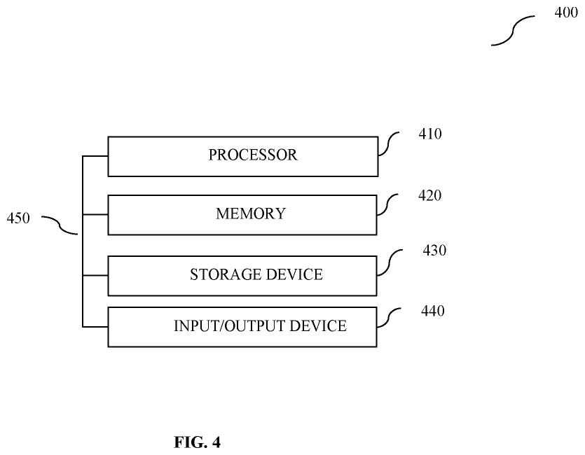

In some implementations, the current subject matter may be configured to be implemented in a system 400, as shown in FIG. 4. For example, the ML model 100 and/or other aspects disclosed herein may be at least in part physically comprised on system 400. The system 400 may include a processor 410, a memory 420, a storage device 430, and an input/output device 440. Each of the components 410, 420, 430 and 440 may be interconnected using a system bus 450. The processor 410 may be configured to process instructions for execution within the system 400. In some implementations, the processor 410 may be a single-threaded processor. In alternate implementations, the processor 410 may be a multi-threaded processor. In some implementations, the processor 410 may comprise one or more of the following: at least one graphics processor unit (GPU), at least one artificial intelligence (AI) chip, at least one ML chip, a neural engine (e.g., specialized hardware that can do fast inference or fast training for neural networks), at least one single core processor, and/or at least one multi-core processor.

The processor 410 may be further configured to process instructions stored in the memory 420 or on the storage device 430, including receiving or sending information through the input/output device 440. The memory 420 may store information within the system 400. In some implementations, the memory 420 may be a computer-readable medium. In alternate implementations, the memory 420 may be a volatile memory unit. In yet some implementations, the memory 420 may be a non-volatile memory unit. The storage device 430 may be capable of providing mass storage for the system 400. In some implementations, the storage device 430 may be a computer-readable medium. In alternate implementations, the storage device 430 may be a floppy disk device, a hard disk device, an optical disk device, a tape device, non-volatile solid state memory, or any other type of storage device. The input/output device 440 may be configured to provide input/output operations for the system 400. In some implementations, the input/output device 440 may include a keyboard and/or pointing device. In alternate implementations, the input/output device 440 may include a display unit for displaying graphical user interfaces.

In view of the above-described implementations of subject matter this application discloses the following list of examples, wherein one feature of an example in isolation or more than one feature of said example taken in combination and, optionally, in combination with one or more features of one or more further examples are further examples also falling within the disclosure of this application:

Example 1. A computer-implemented method comprising:
receiving, at a machine learning model, an input for a task of the machine learning model, wherein the machine learning model comprises a plurality of residual blocks augmented with a plurality of augmented weight blocks that sample intermediate features from the plurality of residual blocks;
applying the input to the machine learning model to perform the task, wherein the applying comprises applying the plurality of intermediate features, which are obtained from the plurality of residual blocks, to the plurality of augmented weight blocks to form a plurality of intermediate outputs; and
generating an output of the machine learning model, wherein the output is generated using at least on a combination of the plurality of intermediate outputs.

Example 2. The method of Example 1, wherein the task comprises image classification, object localization, echo cancellation, and/or speech enhancement.

Example 3. The method of any of Examples 1-2 further comprising: applying the input to a first linear transformation block to increase a dimensionality of the input.

Example 4. The method of any of Examples 1-3, wherein a residual block includes a residual input that is fed forward and summed with the residual input applied to a first nonlinear block and a first linear block to form a residual output.

Example 5: The method of any of Examples 1-4, wherein a first intermediate feature is obtained at a first output of the first nonlinear block.

Example 6. The method of any of Examples 1-5, wherein the plurality of augmented weight blocks each comprise a fully connected neural network and/or a convolutional layer.

Example 7. The method of any of Examples 1-6 further comprising: training the machine learning model using sparse stochastic gradient descent.

Example 8. The method of any of Examples 1-7 further comprising:
in response to sparse stochastic gradient descent converging to a first solution during training, setting to zero one or more weights smaller than a first threshold value.

Example 9. The method of any of Examples 1-8 further comprising: in response to sparse stochastic gradient descent converging to a second solution during training of remaining non-zero weights, setting one or more remaining non-zero weights to zero that are smaller than a second threshold value.

Example 10. A system comprising:
at least one processor; and
at least one memory including code which when executed by the at least one processor causes operations comprising;
receiving, at a machine learning model, an input for a task of the machine learning model, wherein the machine learning model comprises a plurality of residual blocks augmented with a plurality of augmented weight blocks that sample intermediate features from the plurality of residual blocks;
applying the input to the machine learning model to perform the task, wherein the applying comprises applying the plurality of intermediate features, which are obtained from the plurality of residual blocks, to the plurality of augmented weight blocks to form a plurality of intermediate outputs; and
generating an output of the machine learning model, wherein the output is generated using at least on a combination of the plurality of intermediate outputs.

Example 11. The system of Example 10, wherein the task comprises image classification, object localization, echo cancellation, and/or speech enhancement.

Example 12. The system of any of Examples 10-11, further comprising: applying the input to a first linear transformation block to increase a dimensionality of the input.

Example 13. The system of any of Examples 10-12, wherein a residual block includes a residual input that is fed forward and summed with the residual input applied to a first nonlinear block and a first linear block to form a residual output.

Example 14. The system of any of Examples 10-13, wherein a first intermediate feature is obtained at a first output of the first nonlinear block.

Example 15. The system of any of Examples 10-14, wherein the plurality of augmented weight blocks each comprise a fully connected neural network and/or a convolutional layer.

Example 16. The system of any of Examples 10-15, further comprising: training the machine learning model using sparse stochastic gradient descent.

Example 17. The system of any of Examples 10-16, further comprising: in response to sparse stochastic gradient descent converging to a first solution during training, setting to zero one or more weights smaller than a first threshold value.

Example 18. The system of any of Examples 10-17, further comprising: in response to sparse stochastic gradient descent converging to a second solution during training of remaining non-zero weights, setting one or more remaining non-zero weights to zero that are smaller than a second threshold value.

Example 19. A non-transitory computer-readable medium including code which when executed by at least one processor causes operations comprising;
receiving, at a machine learning model, an input for a task of the machine learning model, wherein the machine learning model comprises a plurality of residual blocks augmented with a plurality of augmented weight blocks that sample intermediate features from the plurality of residual blocks;
applying the input to the machine learning model to perform the task, wherein the applying comprises applying the plurality of intermediate features, which are obtained from the plurality of residual blocks, to the plurality of augmented weight blocks to form a plurality of intermediate outputs; and
generating an output of the machine learning model, wherein the output is generated using at least on a combination of the plurality of intermediate outputs.

Example 20. The non-transitory computer-readable medium of Example 20, further comprising: training the machine learning model using sparse stochastic gradient descent.

The systems and methods disclosed herein can be embodied in various forms including, for example, a data processor, such as a computer that also includes a database, digital electronic circuitry, firmware, software, or in combinations of them. Moreover, the above-noted features and other aspects and principles of the present disclosed implementations can be implemented in various environments. Such environments and related applications can be specially constructed for performing the various processes and operations according to the disclosed implementations or they can include a general-purpose computer or computing platform selectively activated or reconfigured by code to provide the necessary functionality. The processes disclosed herein are not inherently related to any particular computer, network, architecture, environment, or other apparatus, and can be implemented by a suitable combination of hardware, software, and/or firmware. For example, various general-purpose machines can be used with programs written in accordance with teachings of the disclosed implementations, or it can be more convenient to construct a specialized apparatus or system to perform the required methods and techniques.

Although ordinal numbers such as first, second and the like can, in some situations, relate to an order; as used in this document ordinal numbers do not necessarily imply an order. For example, ordinal numbers can be merely used to distinguish one item from another. For example, to distinguish a first event from a second event, but need not imply any chronological ordering or a fixed reference system (such that a first event in one paragraph of the description can be different from a first event in another paragraph of the description).

The foregoing description is intended to illustrate but not to limit the scope of the invention, which is defined by the scope of the appended claims. Other implementations are within the scope of the following claims.

These computer programs, which can also be referred to programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, the subject matter described herein can be implemented on a computer having a display device, such as for example a cathode ray tube (CRT) or a liquid crystal display (LCD) monitor for displaying information to the user and a keyboard and a pointing device, such as for example a mouse or a trackball, by which the user can provide input to the computer. Other kinds of devices can be used to provide for interaction with a user as well. For example, feedback provided to the user can be any form of sensory feedback, such as for example visual feedback, auditory feedback, or tactile feedback; and input from the user can be received in any form, including, but not limited to, acoustic, speech, or tactile input.

The subject matter described herein can be implemented in a computing system that includes a back-end component, such as for example one or more data servers, or that includes a middleware component, such as for example one or more application servers, or that includes a front-end component, such as for example one or more client computers having a graphical user interface or a Web browser through which a user can interact with an implementation of the subject matter described herein, or any combination of such back-end, middleware, or front-end components. The components of the system can be interconnected by any form or medium of digital data communication, such as for example a communication network. Examples of communication networks include, but are not limited to, a local area network (“LAN”), a wide area network (“WAN”), and the Internet.

The computing system can include clients and servers. A client and server are generally, but not exclusively, remote from each other and typically interact through a communication network. The relationship of client and server arises by virtue of computer programs running on the respective computers and having a client-server relationship to each other.

The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and sub-combinations of the disclosed features and/or combinations and sub-combinations of several further features disclosed above. In addition, the logic flows depicted in the accompanying figures and/or described herein do not necessarily require the particular order shown, or sequential order, to achieve desirable results. Other implementations can be within the scope of the following claims.

1. A computer-implemented method comprising:
receiving, at a machine learning model, an input for a task of the machine learning model, wherein the machine learning model comprises a plurality of residual blocks augmented with a plurality of augmented weight blocks that sample a plurality of intermediate features from the plurality of residual blocks;
applying the input to the machine learning model to perform the task, wherein the applying comprises applying the plurality of intermediate features, which are obtained from the plurality of residual blocks, to the plurality of augmented weight blocks to form a plurality of intermediate outputs; and
generating an output of the machine learning model, wherein the output is generated using at least on a combination of the plurality of intermediate outputs.

2. The method of claim 1, wherein the task comprises image classification, object localization, echo cancellation, and/or speech enhancement.

3. The method of claim 1, further comprising:
applying the input to a first linear transformation block to increase a dimensionality of the input.

4. The method of claim 1, wherein a residual block includes a residual input that is fed forward and summed with the residual input applied to a first nonlinear block and a first linear block to form a residual output.

5. The method of claim 4, wherein a first intermediate feature is obtained at a first output of the first nonlinear block.

6. The method of claim 1, wherein the plurality of augmented weight blocks each comprise a fully connected neural network and/or a convolutional layer.

7. The method of claim 1, further comprising:
training the machine learning model using sparse stochastic gradient descent.

8. The method of claim 7, further comprising:
in response to sparse stochastic gradient descent converging to a first solution during training, setting to zero one or more weights smaller than a first threshold value.

9. The method of claim 8, further comprising:
in response to sparse stochastic gradient descent converging to a second solution during training of remaining non-zero weights, setting one or more remaining non-zero weights to zero that are smaller than a second threshold value.

10. A system comprising:
at least one processor; and
at least one memory including code which when executed by the at least one processor causes operations comprising;
receiving, at a machine learning model, an input for a task of the machine learning model, wherein the machine learning model comprises a plurality of residual blocks augmented with a plurality of augmented weight blocks that sample a plurality of intermediate features from the plurality of residual blocks;
applying the input to the machine learning model to perform the task, wherein the applying comprises applying the plurality of intermediate features, which are obtained from the plurality of residual blocks, to the plurality of augmented weight blocks to form a plurality of intermediate outputs; and
generating an output of the machine learning model, wherein the output is generated using at least on a combination of the plurality of intermediate outputs.

11. The system of claim 10, wherein the task comprises image classification, object localization, echo cancellation, and/or speech enhancement.

12. The system of claim 10, further comprising:
applying the input to a first linear transformation block to increase a dimensionality of the input.

13. The system of claim 10, wherein a residual block includes a residual input that is fed forward and summed with the residual input applied to a first nonlinear block and a first linear block to form a residual output.

14. The system of claim 13, wherein a first intermediate feature is obtained at a first output of the first nonlinear block.

15. The system of claim 10, wherein the plurality of augmented weight blocks each comprise a fully connected neural network and/or a convolutional layer.

16. The system of claim 10, further comprising:
training the machine learning model using sparse stochastic gradient descent.

17. The system of claim 10, further comprising:
in response to sparse stochastic gradient descent converging to a first solution during training, setting to zero one or more weights smaller than a first threshold value.

18. The system of claim 17, further comprising:
in response to sparse stochastic gradient descent converging to a second solution during training of remaining non-zero weights, setting one or more remaining non-zero weights to zero that are smaller than a second threshold value.

19. A non-transitory computer-readable medium including code which when executed by at least one processor causes operations comprising;
receiving, at a machine learning model, an input for a task of the machine learning model, wherein the machine learning model comprises a plurality of residual blocks augmented with a plurality of augmented weight blocks that sample a plurality of intermediate features from the plurality of residual blocks;
applying the input to the machine learning model to perform the task, wherein the applying comprises applying the plurality of intermediate features, which are obtained from the plurality of residual blocks, to the plurality of augmented weight blocks to form a plurality of intermediate outputs; and
generating an output of the machine learning model, wherein the output is generated using at least on a combination of the plurality of intermediate outputs.

20. The non-transitory computer-readable medium of claim 19, further comprising:
training the machine learning model using sparse stochastic gradient descent.
